(19) United States
(12) Patent Application Publication
(10) Pub. No.: US 2017/0139893 A1
(43) Pub. Date: May 18, 2017

(54) AUTOMATICALLY ADJUSTING SPREADSHEET FORMULAS AND/OR FORMATTING

(71) Applicant: Smartsheet.com, Inc., Bellevue, WA (US)

(72) Inventors: Erik Rucker, Seattle, WA (US); Thomas P. Maliska, JR., Olympia, WA (US)

(73) Assignee: Smartsheet.com, Inc., Bellevue, WA (US)

(21) Appl. No.: 15/347,630

(22) Filed: Nov. 9, 2016

Related U.S. Application Data
(60) Provisional application No. 62/254,585, filed on Nov. 12, 2015.

(51) Int. Cl. G06F 17/24; G06F 17/21

(52) U.S. Cl. CPC G06F 17/246; G06F 17/211

(57) ABSTRACT

In some embodiments, if a Master Row is associated with tabular data, a formatting operation replicates formatting from the Master Row in any new row created at the same level of hierarchy in the tabular data. In some embodiments, the tabular data editor allows users to specify whether formatting set by a user edit in a cell before application of a Master Row results in a merger or override. In some embodiments, formatting set by a user edit after a Master Row is applied is treated as custom edit to that cell or row, and is not again changed to match the Master Row (unless the hierarchy of the row changes, and another Master Row is applied).

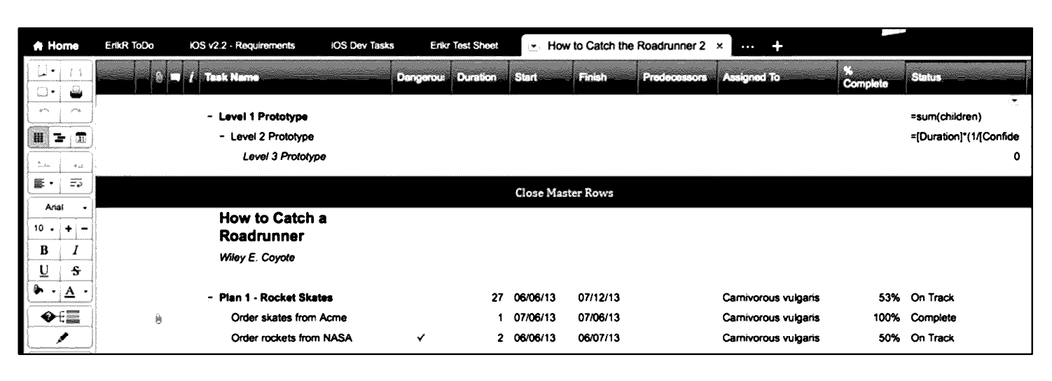

### CROSS-REFERENCE TO RELATED APPLICATION

This application claims the benefit of Provisional Application No. 62/254,585, filed Nov. 12, 2015, the disclosure of which is hereby incorporated herein in its entirety for all purposes.

### DESCRIPTION OF THE DRAWING

The foregoing aspects and many of the attendant advantages of this invention will become more readily appreciated as the same become better understood by reference to the following detailed description, when taken in conjunction with the accompanying drawing, wherein:

The FIGURE illustrates an example embodiment of an interface for editing master row information and testing formulas according to various aspects of the present disclosure.

### DETAILED DESCRIPTION

Given a set of defined column types and canonical formulas and formatting in a presentation of tabular data such as a spreadsheet, sheet, or other tabular data, when a user wants to build a new table of columns with interrelated formulas, the user can enter data in any column. In response, it is desirable that the formulas, with reference to precedence rules, setup and evaluate correctly. In commonly owned, co-pending U.S. patent application Ser. No. 14/574,003, the entire disclosure of which is hereby incorporated by reference herein in its entirety, application of a suite of rules was described which ordered formatting and applied formulas based on algorithmic inspection of adjoining rows. However, those rules assume some system of rows exist, in order to inspect the sheet areas and determine which rows share formatting and formulas. In some embodiments of the present disclosure, techniques are provided to create a master set of formulas as templates to apply to sheet operations. In some embodiments of the present disclosure, techniques are provided to prepare and test formulas (sandboxing) with sample data.

This is a technical problem concerning the use and behavior of column cell values based on formulas. Existing systems for managing tabular data would require specific programming of behavior in order to make the column cell formulas program themselves independently based on hierarchy level. However, it is difficult to maintain such programming overlays and to make them comply with expected behavior in the spreadsheet, especially when changes are made to the formulas in the sheet, and more so when changes are made by non-programmers doing data entry, spreadsheet maintenance, adapting spreadsheets for other uses, and the like.

Also, given the complexity of the references when there are many cross-referenced formulas, or for a sheet of reasonable size, it may be difficult or not realistically possible to trace through sheets to find the source of errors. Setting aside the computational errors that may occur with manually entered or pasted formulas, formatting also presents a problem. Maintaining formatting consistency becomes more difficult when users input rows manually, when the hierarchy level of a row changes, where the formatting must be added to match existing presentation, or by pasting rows from other sources, where the formatting is different. Further, after such acts it may be difficult or not realistically possible to determine which formatting of rows is preferred, expected or correct. It is further difficult to compare sheets, logically or visually, between versions where the desire is to maintain formatting and consistent formula application, but there are no preset standards or automation enforcement of them.

Existing markup tools for comparing sheets or reviewing their design patterns provide, in the main, overlays on the main sheet which show formula and formatting usage patterns, often in variegated colors. These displays require an understanding of the editing software, independent of the sheet, and can be confusing to the lay user. It is an improvement to separate the creation of master rows with formulas and formatting, for direct application to the sheet, and to set constraints on whether and when direct user manipulation of a sheet may occur. To some extent, this separates data entry from sheet formula design and programming steps, as well, reducing errors resulting from simply copying areas from similar sheets as a shortcut for sheet design.

Further, some embodiments of the present disclosure allow the creation of a hierarchy of formulas, which can be re-used independently from a given sheet. Master formulas may be saved with a sheet, as a template for sheet design, or as a prototype sheet for testing with sample data. The so-called master formulas may be applied to a sheet to formalize its formatting and operations. This also separates for logical review the master formulas, as a whole, from the data specific to a given sheet, which aids in the review and programming of sheets. This maintains programming consistency, ensures correctness of evaluation, and avoids human error.

### Master Row Editing

In some embodiments, an area is created for master row editing and formula testing, separate from the sheet. In some embodiments, this may be a collapsible area of rows at the start or end of the sheet. In some embodiments, this may be a separate interface, such as a separate sheet, a configuration dialog, and/or the like. One master row may be created for specific hierarchy levels in the sheet design. The master rows are associated with the sheet, but are not considered by the system to be a part of the sheet under evaluation. Since the master rows determine formula operations and formatting, formulas from a master row may be applied to the sheet whenever a hierarchy change occurs at the level associated with that master row, whenever data entry into a new or existing row occurs, or in response to any other suitable trigger.

The FIGURE illustrates an example embodiment of an interface for editing master row information and testing formulas according to various aspects of the present disclosure. In this FIGURE, the master row edit area appears at the top, and contains formatting and formulas to be applied to rows in the sheet being edited. If a hierarchy level does not have an associated Master Row, it may maintain direct edits applied by the user to the row in the body of the sheet—unless a Master Row for that level of the sheet hierarchy is subsequently created and applied. Upon creation of the master row, a user interface for the selection of the master row may be presented, for example, an interface asking the user “do you want to replace with the master row contents here?” or similar). With such a user interface, the user may directly select and apply formatting from the master rows to rows in the body of the sheet.

Formatting applied to each cell in the master rows (in the example, rows a-c of the upper section) would be copied into the other rows at that level in the sheet being edited, below (in the example, rows 1-6 of the lower section). Formulas may also be specific to each hierarchy level and can be explicitly defined (as shown in the example, in the column ‘Status’).

As discussed above, master rows are in a special area on the sheet (or in a separate interface and associated with the sheet) and may be hidden by default. They don't appear as regular rows within the body of the sheet, so they are not deleted when a user clears data from a sheet under design.

In some embodiments, the general behavior is as follows:
1. If a Master Row is present, the formatting operation replicates formatting from the Master Row in any new row created at the same level of hierarchy in the sheet.
2. In some embodiments, the editor allows users to specify whether formatting set by a user edit in a cell before application of a Master Row results in a merger or override;
3. In some embodiments, formatting set by a user edit after a Master Row is applied is treated as custom edit to that cell or row, and is not again changed to match the Master Row (unless the hierarchy of the row changes, and another Master Row is applied).

In this way, Master Rows serve as design prototypes for the hierarchy levels in the sheet, and can be chosen and applied through the sheet UI. A variety of sheet designs can be available and selectively applied.

In some embodiments, Master Rows can also be added to sheets by choosing or designing a Master Row template and applying it to the sheet.

In some embodiments, Master rows may be edited, imported, saved with sheets, and saved as templates for association with other sheets.

In some embodiments, the explicit prototype rows created by the user would be in the ‘Master Rows’ area associated with the sheet. There may be one master row, with formulas and/or formatting, associated with each hierarchical level in the sheet. The Master Rows would not be in the body of the sheet proper, but would be stored in association with the sheet. The formulas and/or formatting specified in the Master Rows may over-ride sheet-based inspection and formatting rules for rows in the body of the sheet when applied.

Further, in some embodiments, the application of the formulas and/or formatting specified in the Master Rows may be tested in the context of the Master Rows special area, in ‘sandbox’ testing applied to data rows within the Master Rows special area. In some embodiments, the Master Rows processing may be applied and tested within the body of the sheet, subject to standard Undo processes for the sheet.

In some embodiments, the sandbox testing area may fill in sample data to help user ‘see’ how format and/or formula calc works, without changing the data in the body of the sheet. In some embodiments, a mouse hover over may allow a user to see formulas underneath, or the user may switch modes between formula and data with a gesture or click. This sample data can then show intuitively how the formulas look when calculated (but such data is not imported to the main sheet).

In some embodiments, ‘formula sets’ may be provided. The original five rules using sheet inspection (as described in the '003 patent application incorporated above) may be used as a canonical default set; but users could save customized sets and related formats, test and apply them, using formula sets instead. This would also allow the creation of ‘in situ’ templates over an active sheet—for example, as some rules are temporal (for example, reporting and compliance formulas in accounting sheets, which rules change year to year), those could be modified in a Master Row while not having to make direct changes to the underlying accounting sheet structure. This would include the ability to Save As a sheet design template, keeping the custom rule set in the Master Row/sandbox area; Save As a sheet schema, saving without data or formula results as a ‘master sheet’; or Save As a named sheet with both data and sheet rules applied.

In some embodiments, the fixup functionality may operate on columns that are locked and/or hidden just as though they were unlocked and visible. Imagine a scenario where there's a column full of revenue calculations, where for child rows the formula is “=price*quantity” and for parent rows the formula is “=sum(children)”. The sheet creator doesn't want sheet users modifying the formulas directly, but needs the formula to change when the sheet user promotes or demotes a row. She can manage this by creating the formulas in the master rows and then locking the column.

Similarly, rows that are locked and/or hidden may be treated for fixup as though they were unlocked and visible (locked or hidden rows may have their hierarchy level changed by a change to one of their parent rows). Imagine a sheet with 3 levels of hierarchy but data that exists only at the topmost and 2nd levels of that hierarchy, and with some rows at the 2nd level hidden (either directly or by a filter). If the sheet user selects a row currently at the topmost hierarchy level and demotes it, she now has data at all 3 hierarchy levels. Even though some of the rows at the old 2nd hierarchy level were hidden, they will be demoted to the 3rd level by the creation of the new top level. This is done to keep the hierarchy intact.

While illustrative embodiments have been illustrated and described, it will be appreciated that various changes can be made therein without departing from the spirit and scope of the invention.

1. A computer-implemented method of automatically modifying a computerized information display, the method comprising:
detecting, by a computing device, that a trigger indicating an updated row in a spreadsheet has been activated;
reviewing, by the computing device, a set of master rows to determine if the updated row should be automatically modified based on a corresponding master row; and
in response to identifying a corresponding master row to be used to modify the updated row, modifying, by the computing device, the updated row based on the identified master row.
